(19) United States
(12) Patent Application Publication
(10) Pub. No.: US 2008/0146390 A1
(43) Pub. Date: Jun. 19, 2008

(54) Constant torque variable speed drive train

(76) Inventor: Alejandro Lacreu, New York, NY (US)

Correspondence Address: AMSTER, ROTHSTEIN & EBENSTEIN LLP, 90 PARK AVENUE, NEW YORK, NY, 10016, US

(21) Appl. No.: 11/642,309

(22) Filed: Dec. 19, 2006

(51) Int. Cl. F16H 7/00; F16H 29/04

(52) U.S. Cl. 474/68; 474/80

(57) ABSTRACT

A drive train system for human powered vehicles whereby the pedals move in a linear or slightly curved path, providing a superior ergonomic ride. Power is transmitted from the pedals by a flexible drive tension transmitting component to two one way locking continuous variable radius helicoids mounted on a shaft by means of a one way locking mechanism. The pedals move alternatively back and forth pulling the cables and unwinding (active phase) their corresponding helicoids and thus transferring spinning motion to the shaft. The helicoids act as a set of sprockets of continuous variable radius optimizing the ergonomic delivery of leg power to the shaft. A step-less shifting system alters the length of cable wound in the helicoids and can manually select the “zone” of the helicoids utilized for optimal power transmission. This gearing system can manually adjust the power-speed ratio according to the environment demands, akin to a gear system.

### BACKGROUND

The concept of a human powered vehicle (“HPV”) has been contemplated since before the drawings by Da Vinci depicting designs for bicycles and helicopters. The ancient Chinese and Egyptians tried to produce an HPV for ground transportation. Only since the late 18th century, with the emergence of practical pedal operated HPVs including tricycles and bicycles, has there been an increased focus on improving the efficiency of such vehicles. Most of the development has attempted to improve the efficiency of the power train by reducing weight and friction, the ergonomic position of the rider (recumbent) and aerodynamics (fairing).

A person driving an HPV will typically, though not exclusively, use their legs to exert force on a pair of pedals attached, through a pair of crank arms, to a drive pulley. The torque force exerted through the crank arms imparts a spinning motion to the drive pulley. The spinning motion of the drive pulley is transmitted, often through a chain or other flexible component, to a driven pulley which is typically attached to a drive wheel or propeller depending on the kind of HPV.

This traditional crank system fully utilizes the actuating force applied to the pedals only when the direction of the force is perpendicular to the crank arm. In addition, for practically the entire rotational circuit of the pedals the force exerted by the rider is discomposed into two forces, one useful and the other wasted. The first force imparts a torque on the crank arms, i.e. useful force. The second force acts only upon the crank arm itself, alternatively compressing and tensioning the crank arm, i.e. the wasted force. The driver will take advantage of first force to create the torque necessary for the spinning motion while the second component force is wasted.

### SUMMARY OF THE INVENTION

The present invention relates to a new transmission suitable for use in any HPV operating on land, air or water. The present invention directly addresses the variability of power delivered by the leg or arm through its active cycle. By virtue of using the primarily linear motion of the pedals it also eliminates the inherent inefficiencies of the traditional leg-crank arrangement that creates waste components to the actuating force.

A transmission mechanism is disclosed having a first and second helicoid and a shaft. The shaft has a first end, a second end and a drive direction. The first helicoid is attached to the first end of the shaft and the second helicoid is attached to the second end of the shaft.

A flexible drive tension transmitting component having a first drive end and a second drive end wherein the first drive end is attached to the first helicoid adjacent the center thereof and the second drive end is attached to the second helicoid adjacent the center thereof. A flexible return tension transmitting component having a first return end and a second return end wherein the first return end is attached to the first helicoid adjacent a circumferential edge thereof and the second return end is attached to the second helicoid adjacent a circumferential edge thereof.

A first tension force transmitted through the flexible drive tension transmitting component causes a first drive portion of the flexible drive tension transmitting component adjacent the first drive end to unwind from the first helicoid. This unwinding forces the shaft to rotate in the drive direction. Simultaneously, a first portion of the first flexible return tension transmitting component adjacent the first return end is caused to wind around the first helicoid and reset the second helicoid. This winding of the first return end around the first helicoid causes the second return end to unwind from the second helicoid and, thus, the resetting of the second helicoid, i.e. winding the second drive end around the second helicoid.

A second tension force transmitted through the flexible drive tension transmitting component causes a second drive portion of the flexible drive tension transmitting component adjacent the second drive end to unwind from the second helicoid. This unwinding forces the shaft to rotate in the drive direction. Simultaneously, a second portion of the flexible return tension transmitting component adjacent the second return end is caused to wind around the second helicoid and reset the first helicoid. This winding of the second return end around the second helicoid causes the first return end to unwind from the first helicoid and, thus, the resetting of the first helicoid, i.e. winding the first drive end around the first helicoid.

A pair of pedals may be attached to the flexible drive tension transmitting component.

A first one way locking mechanism, e.g. a freewheel, is disposed between the first helicoid and the first end of the shaft and a second freewheel is disposed between the second helicoid and the second end of the shaft.

A gearing system comprising a plurality of pulleys attached to a plate or plates actuatable with respect to the first and second helicoids may also be included in the transmission system. The flexible drive tension transmitting component and the flexible return tension transmitting component can engage the plurality of pulleys and actuation of the plate may cause a change in the length of first and second drive portions and first and second return portions that engaged each helicoid.

Each helicoid may further comprise a groove sized to receive the flexible drive tension transmitting component and the flexible return tension transmitting component.

### BRIEF DESCRIPTION OF THE DRAWINGS

The above and related objects, features and advantages of the present invention will be more fully understood by reference to the following detailed description of the presently, albeit illustrative, embodiments of the present invention when taken in conjunction with the accompanying drawing wherein:

FIG. 1a is a top view of helicoid 2;

FIG. 1b is a side view of helicoid 2;

FIG. 2 is a simplified schematic diagram of the drive system of the present invention;

FIG. 3 is a simplified schematic diagram of the return system of the present invention;

FIG. 4 is a simplified schematic diagram of the gearing system of the present invention;

FIG. 5 is a simplified schematic diagram of the transmission of the present invention including the drive system, the return system and the gearing system;

FIG. 6 is a schematic view of the transmission of the present invention mounted on an exemplary human powered vehicle;

FIG. 7 is a schematic view of an alternative embodiment of the present invention mounted on an exemplary human powered vehicle; and

FIG. 8 is a simplified schematic diagram of the transmission of an alternative embodiment of the present invention including the drive system, the return system and the gearing system.

### DETAILED DESCRIPTION OF THE INVENTION

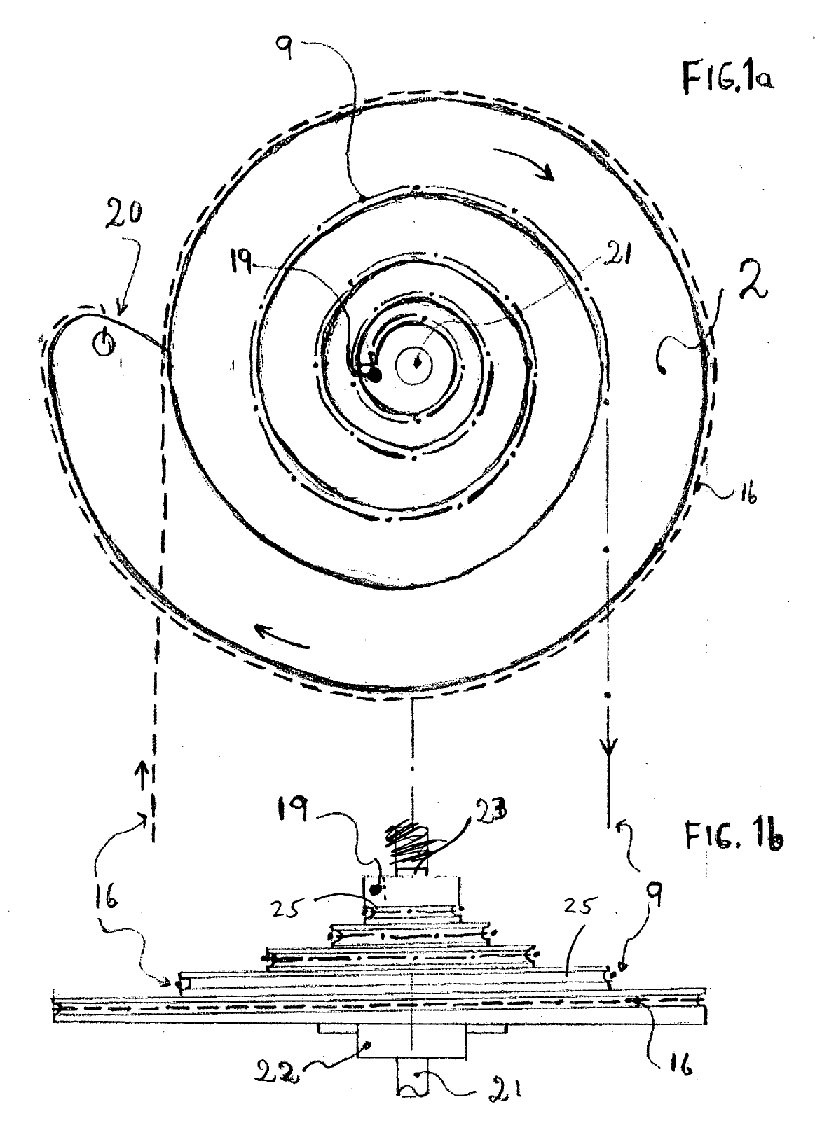

FIGS. 1a and 1b are top and side views, respectively, of one possible embodiment for a ‘helicoid’ for use in the present invention. Each helicoid has an attachment point 19 for flexible drive cable 9 and another attachment point 20 for return cable 20. Each helicoid is capable of engaging flexible drive cable 9 and flexible return cable 16 and may be provided with a helicoid groove 25 to assist in this engagement. Although the illustrated helicoid defines a substantially round 3-dimensional spiral engagement portion, this does not limit the invention. The term “helicoid” as used with regard to the present invention, includes any 3-dimensional element capable of engaging flexible drive and/or return tension transmitting components, e.g. cables 9 and/or 16, in three spatial dimensions.

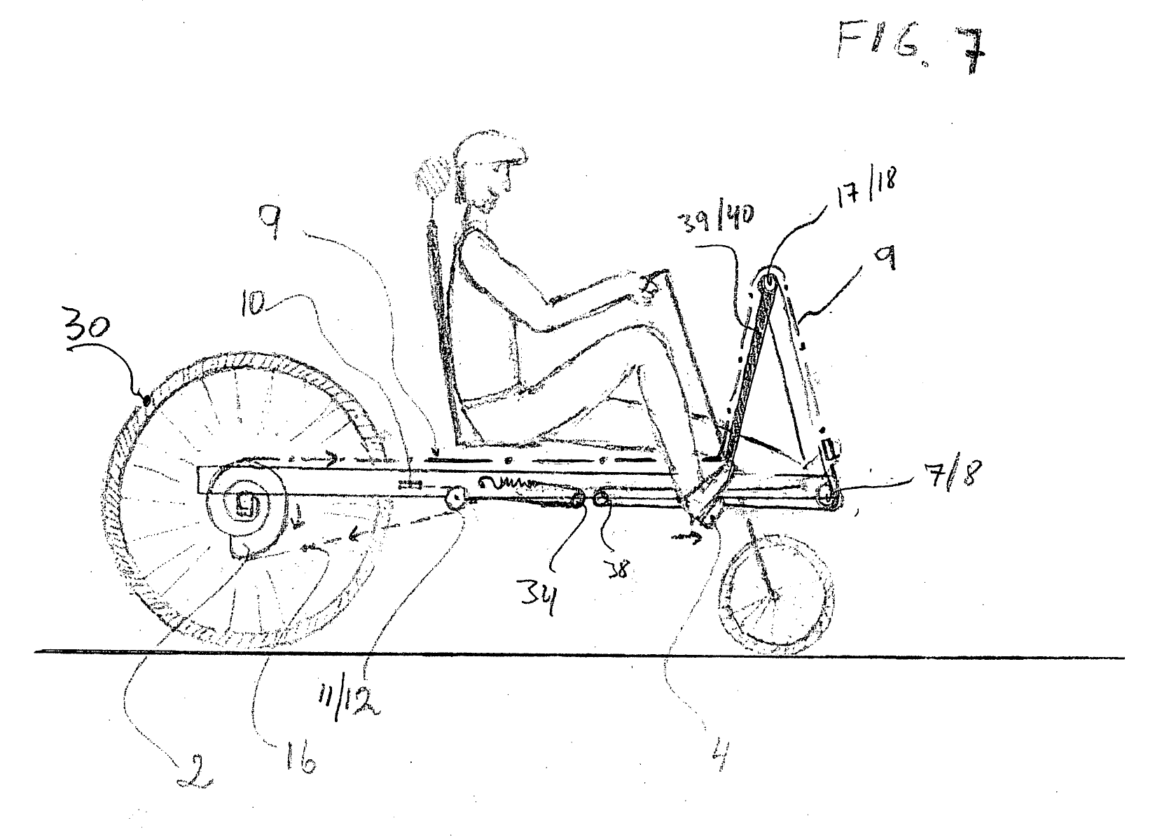

FIG. 6 shows an exemplary HPV incorporating an embodiment of the transmission system of the present invention. Each of the pedals 3, 4 move along a straight or slightly curved guide in a reciprocating motion. As most simply shown in FIG. 2, each of pedals 3, 4 are attached to drive cable 9. Drive cable 9 passes over pulleys 5, 7, 8 such that movement of pedal 3 in one direction results in movement of pedal 4 in the opposite direction and vice versa. The reciprocating force applied through pedals 3, 4 is transmitted through drive cable 9, helicoids 1, 2 and one way locking bearing 22 to shaft 21. Shaft 21 is rigidly attached to the portion of the HPV which is to be made rotate, e.g. drive wheel 30 in FIG. 6.

FIG. 2 discloses the circuit of drive cable 9 through which the force exerted on pedals 3, 4 is transmitted to drive wheel 30. Drive cable 9 is connected to corresponding continuous variable radius helicoids 1, 2 mounted symmetrically on ends 23 of shaft 21 with a one way locking bearing or freewheel 22. By “continuous” it is meant that the change of the radius of helicoids 1, 2 along helicoid groove 25 is continuous from a minimum radius at drive cable connection point 19 to a maximum radius at return cable connection point 20. Both ends of the drive cable 9 are affixed to the helicoids 1, 2 radially adjacent the shaft end 23 at drive cable connection point 19.

As pedal 3 is pressed forward the drive cable 9 is forced to unwind from helicoid 1 resulting in the transmission of force from pedal 3 through drive cable 9, helicoid 1 and freewheel 22 to the shaft 21. Force exerted on pedal 4 results in transmission of force through drive cable 9 and helicoid 2 to the shaft 21. As is well known to workers in the art, pedals 3, 4 may also be supplied with a foot cage (not shown) or shoe attachment such that a ‘pulling’ force may be exerted by the rider in addition to the force exerted on pedals 3, 4 ‘pushing’ them away from the rider. The pulling force will act on the opposite helicoid, i.e. pulling on pedal 3 will result in force on helicoid 2.

A return cable 16 is attached to the helicoids at return cable connection point 20. Connection point 20 is adjacent the point of maximum radius of the helicoids 1, 2. Return cable 16 is wound around the helicoid as the drive cable 9 unwinds from the same helicoid, drive cable 9 being forced to unwind by force exerted on pedals 3, 4. Winding of one end of the return cable 16 results in the opposite end of the return cable 16 unwinding from the other helicoid. The force exerted by the return cable 16, causing the return cable to unwind, also causes the portion of drive cable 9 associated with that helicoid to be wound around the helicoid. This ‘reset’ of the drive cable 9 by the return cable 16 causes the pedal directly associated with that helicoid to return to its start position.

Thus, pushing force exerted on pedal 4 causes unwinding of drive cable 9 from helicoid 2, winding of return cable 16 around helicoid 2, unwinding of return cable from helicoid 1 and winding of drive cable 9 around helicoid 1. The reciprocal force, i.e. pushing force exerted on pedals 3, causes unwinding of drive cable 9 from helicoid 1, winding of return cable 16 around helicoid 1, unwinding of return cable from helicoid 2 and winding of drive cable 9 around helicoid 2.

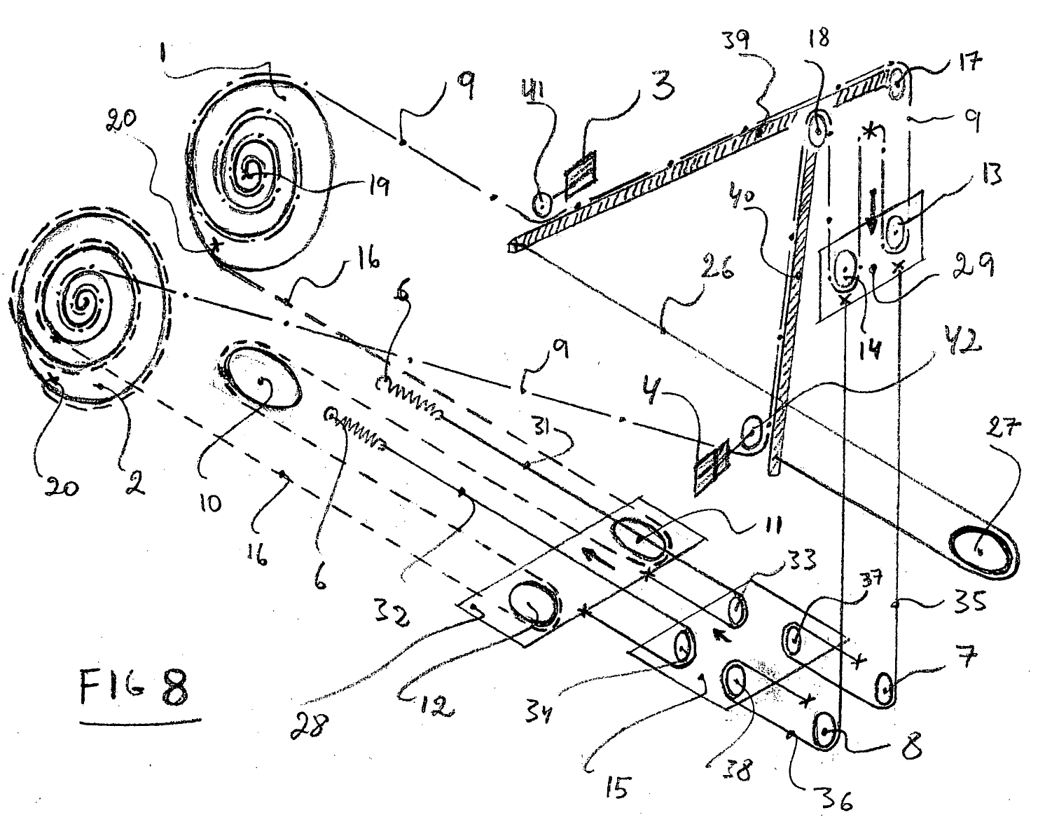

In an alternative embodiment, pedals 3, 4 can be attached to a pair of levers. This alternative embodiment is shown in FIGS. 7 and 8. The length of levers are such that the arc described by the pedals from a start position to an stop position is only a small portion of a full circle. This being the case, the curve defined by the path of pedals 3, 4 is only slightly curved. The path of the pedals 3, 4 is primarily perpendicular to the fulcrum.

The benefits of the present transmission include the ergonomic delivery of muscle power. In each stroke, the system offers a larger fulcrum (greater radius of the helicoids) corresponding with the lesser force that a leg or arm, i.e. the extremity, is capable of exerting in the flexed position. As the stroke progresses and the force exerted by the extremity increases by virtue of extension, the available fulcrum decreases because the drive cable 9 is pulling on the helicoid at a smaller radius. The force increases while the radius of the helicoid to which the drive cable 9 transmits the force decreases. Thus, the torque remains fairly constant.

In other words, when the pedal 3 is in the start position the leg is flexed and, therefore, the muscles are capable of their lowest force capacity. At this point the drive cable 9 is completely wound on the helicoid 1 so that radius is larger and the force required for a certain torque is smaller. When the pedal 3 attached to helicoid 1 is about to reach its end position the leg is extended and the muscles have a high force capacity. At this point drive cable 9 is mostly unwound from helicoid 1 and, therefore, acts on a smaller radius of helicoid 1. Also, at this end position the helicoids, and thus the wheel or propeller, achieve a higher speed than at the start position.

The absence of a traditional crank interface between the force, e.g. the rider's feet on the pedals, and the transmission eliminates the loss of power to components of the action force. Note that the traditional crank system utilizes the action force fully only when the direction of the force is perpendicular to the fulcrum. Keeping the action force perpendicular to the fulcrum around 360° of a traditional crank is very difficult for a rider to achieve. The linear pedal system also results in a more compact profile in relation to the direction of travel of a the HPV, permitting the adoption of better aerodynamic devices.

All of the above characteristics contribute on the efficiency of the transmission for any kind of HPV.

Referring first to FIG. 1a, there is a top view of one of the two helicoids; helicoid 2 is shown and the arrows disclose helicoid 2 rotating in the drive direction, i.e. clockwise. The drive cable 9 is attached to the drive cable connection point 19 and has already unwound approximately 360° from helicoid 2. The return cable 16 is attached to the helicoid 2 at return cable connection point 20 and has already wound approximately 360° around helicoid 2.

FIG. 1b is a side elevation of helicoid 2. Helicoid 2 is a solid three dimensional spiral on which can be wound cables 9 and 16, belts or other flexible components capable of transmitting a tension force. A helicoid groove 25 may be provided to receive and retain the flexible tension transmitting component or components. In this particular arrangement the helicoid 2 is connected to end 23 of a shaft 21 through a one way locking bearing 22 like a freewheel, thus when the helicoid 2 spins in the direction it is desired to drive the shaft 21, it transfers torque to the shaft 21 but when it spins counter to the direction it is desired to drive the shaft 21, it does not transfer any significant torque. Such a freewheel arrangement does not interfere with the shaft 21 moving in the driven direction when the helicoid is not driving the shaft 21.

FIG. 2 shows the drive system on which both helicoids are attached to ends 23 of shaft 21. The drive cable 9 is completely wound on the right helicoid 2 and completely unwound on the left helicoid 1. So helicoid 2 is at the start position and the helicoid 1 is at the end position. The drive cable 9 is disposed from helicoid 2 to helicoid 1 through the front guide pulleys 7 and 8. Between the two front guide pulleys 7 and 8 it is the drive pulley 5 attached to the tension spring 6 which maintains tension in the entire system. The other end of tension spring 6 is attached to frame 24.

Between helicoid 2 and the right front guide pulley 8 attached to the drive cable 9 is the right pedal 4 and between helicoid 1 and the left front guide pulley 7 attached to the drive cable 9 it is the left pedal 3. Pedals 3 and 4 may be guided by a guide slot, rail or lever supported on or in the frame 24 of the HPV. In FIG. 2 pedal 4 is ready to be pushed to the front to remove cable 9 from helicoid 2, making it spin clockwise, i.e. in the drive direction of helicoid 2. At the same time cable 9 is pushed through pulley 5, 7 and 8, allowing pedal 3 to move backward. The drive system makes helicoid 2 spin clockwise (viewed from the top of the helicoid, as in FIG. 1A) in the drive direction and helicoid 1 spin counter-clockwise in the drive direction by removing drive cable 9 from each, alternating one at a time.

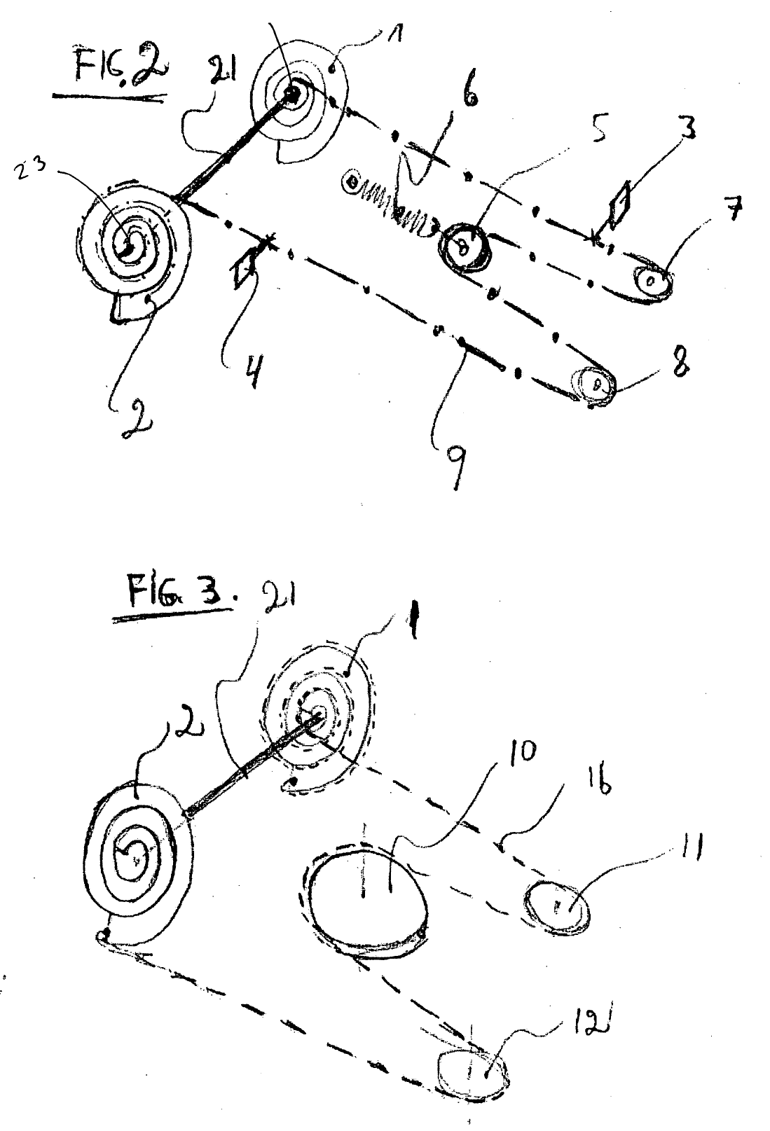

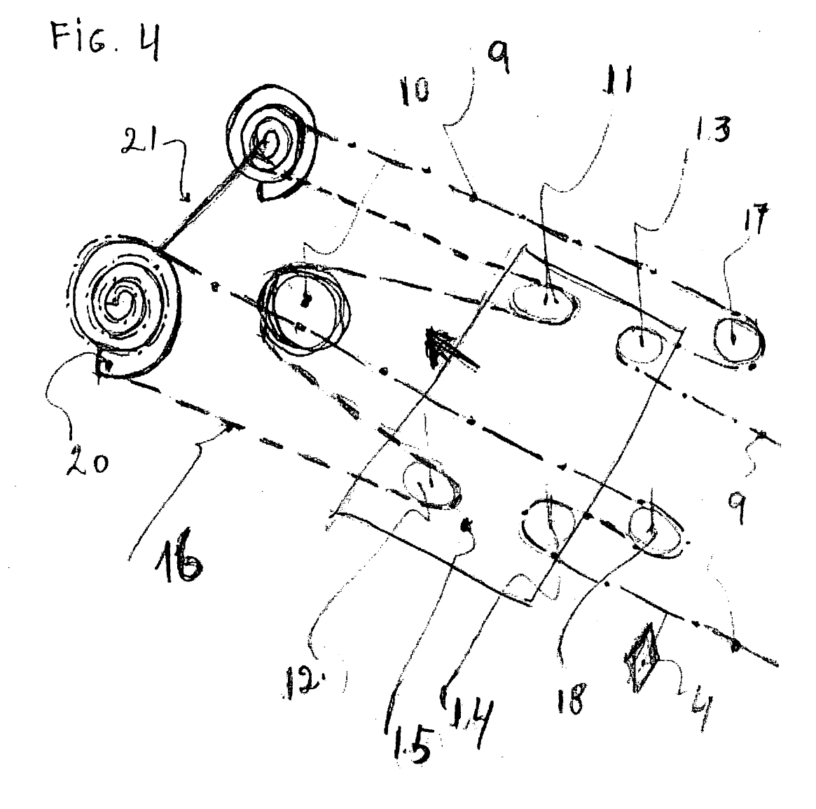

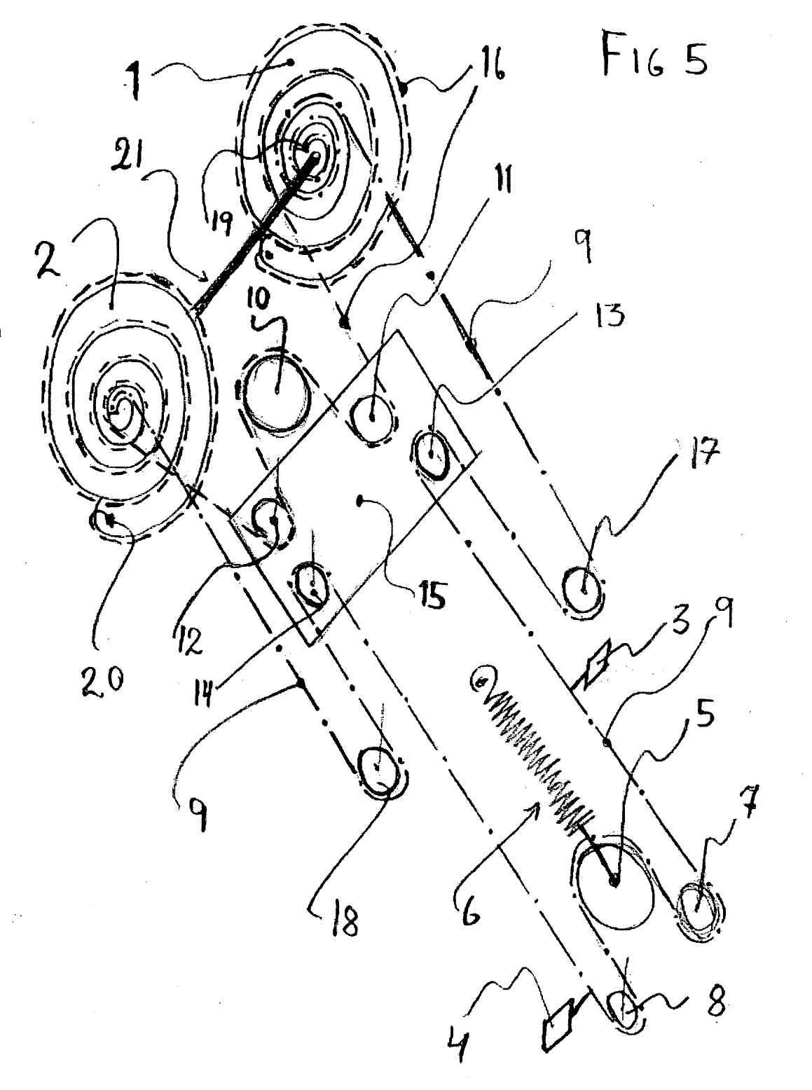

FIG. 3 shows the return system which makes the non-drive helicoid spin in the non-drive direction in order to return (rewind) the drive cable to the start position on the non-drive helicoid. The arrangement shows both helicoids on the same position as shown in FIG. 2. Opposite from the drive cable 9, the return cable 16 is completely unwound from helicoid 2 and completely wound on helicoid 1. When pedal 4 is pushed, helicoid 2 spins clockwise the return cable 16 is pulled onto helicoid 2. The return cable 16 being pulled onto helicoid 2 pulls the other end of return cable 16 from helicoid 1, with the center of return cable traveling across return pulley 10. The same effect, with opposite winding and unwinding, will occur when pedal 3 is pushed.

The length of cable each helicoid 1, 2 holds can be equal to the distance that each pedal 3 and 4 can travel from the back (start position) to the front (end position). Thus each time a pedal 3 and 4 is pushed from its start position to the end position the cables 9 and 16 will wind or unwind completely to and from the helicoids. However, it is not necessary that the cables 9 and 16 each wind or unwind completely for each back-and-forth trip of pedals 3, 4. The variable winding option may be exploited into an effective gearing system, i.e. allowing for the larger radii portions of the helicoids to be utilized at low speeds when higher torque from lower force is desired and allowing for the lower radii portions of the helicoids to be utilized at high speeds when more force is available to maintain a higher speed of shaft 21.

FIG. 4 shows a schematic diagram of the gear system including a set of four gear pulleys 11, 12, 13 and 14 attached to a gear plate 15. Gear plate 15 and, thus, attached gear pulleys 11, 12, 13 and 14, are moveable towards and away from helicoids 1, 2. The return gear pulleys 11 and 12 hold a portion of the return cable 16 and the drive gear pulleys 13 and 14 hold a portion of the drive cable 9.

In the arrangement shown in this FIG. 4 the gearing system is set for near optimal performance for a relatively slow speed. The right pedal 4 is at the start position, the drive cable 9 is wound on helicoid 2 and the return cable 16 is unwound from helicoid 2. Return cable 16 is disposed over return gear pulleys 11 and 12 which are between each helicoid 1, 2 and return pulley 10, return cable 16 then engages helicoid 1. Because of the placement of the gear plate 15 and the length of cable the helicoid can hold being larger than the distance each pedal can travel from back to front, return cable 16 only wraps about halfway around helicoid 1. The remainder of helicoid 1, again only about half, is occupied by drive cable 9. With this arrangement, force applied to pedal 4 from its start position to its end position will act only on the outer, greater radii, portion of helicoid 2. As this force is applied, return cable 16 causes drive cable 9 to be wound around the outer half of helicoid 1, resetting helicoid 1 as pedal 3 returns to its start position.

In order for the gearing system to be better optimized for higher speed, drive cable 9 has to be removed from both helicoids to make the drive cable 9 work on the lesser radii portions of helicoids 1, 2. Movement of gear plate 15 in the direction toward helicoids 1, 2, shown by the arrow in FIG. 4, accomplishes this optimization for high speed or for intermediate speeds in between high and low speeds. This movement of gear plate 15 causes gear pulleys 13, 14 to move away from guide pulleys 17, 18 and for helicoids 1, 2 to release the drive cable 9 required to fill the added distance between pulleys 13, 14 and 17, 18.

Movement of the gear plate 15 will also cause additional return cable 16 to be wound around each helicoid 1, 2. The decrease in the distance between pulleys 11, 12 and return pulley 10 makes the return cable 16 available to be wound further around helicoids 1, 2.

Thus, movement the gear plate 15 toward helicoids 1, 2, as the arrow shows in FIG. 4, will simultaneously unwind the drive cable 9 from helicoids 1, 2, making available to be driven by pedal 4 the lesser radii portions of both helicoids, and wind additional return cable 16 around helicoids 1, 2 to allow the return cable to properly rewind drive cable 9.

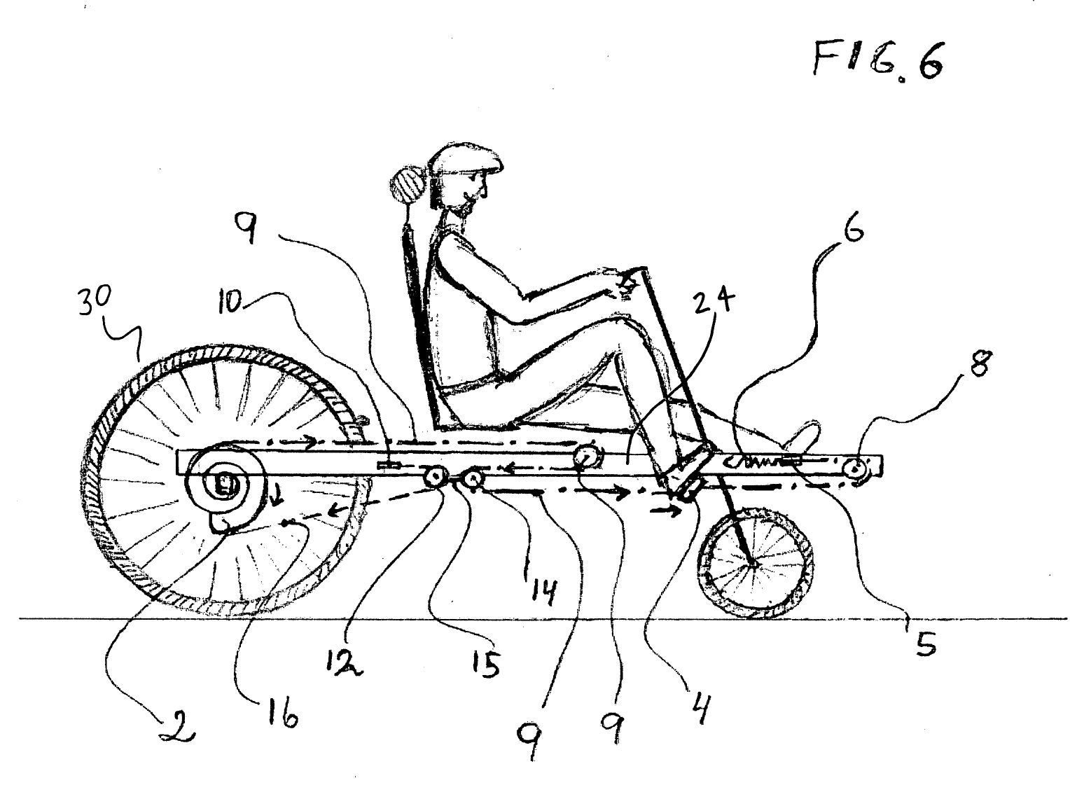

FIG. 5 is a schematic diagram showing the entire transmission system of the present invention. Helicoid 2 and the right pedal 4 are at the end position and, helicoid 1 and the left pedal 3 are at the start position. FIG. 5 shows the gearing system at or near its highest speed setting.

FIG. 6 shows one example of an HPV in which right pedal 4 is at the start position. Pedal 4 is rigidly attached to drive cable 9 and is slidably guided relative to HPV frame 24. From the start position, pedal 4 is ready to have force exerted on it by the rider's right foot. Such force will pull the portion of drive cable 9 attached to pedal 4 forward, unwinding drive cable 9 from helicoid 2 making it spin clockwise and driving, through one way locking bearing 22 and drive shaft 21, wheel 30 in a clockwise direction (viewed from the side of the wheel on which helicoid 2 is disposed). At the same time, the return cable 16 is using the clockwise movement of helicoid 2 to wind drive cable 9 around helicoid 1 thus returning helicoid 1 to the position at which pedal 3 can impart a driving force thereon. Also simultaneously with these actions of the drive cable 9, return cable 16 and helicoids 1, 2, pedal 3 moves from its end position to its start position.

FIG. 7 shows another example of an HPV in which the pedals are attached to a pair of levers 39 and 40. A first end of drive cable 9 passes from helicoid 1, engages lever 39 at pedal 3 pulley 41, passes over pulleys 17 and 13 and is rigidly attached to the frame 24 at connection point 43 and a second end of drive cable 9 passes from helicoid 2, engages lever 40 at pedal 4 pulley 42, passes over pulley 18 and 14 and is rigidly attached to the frame 24 at connection point 43. Drive cable 9 can be a single cable rigidly attached near its center to frame 24 at connection point 43 or two separate cables. Lever cable 26 is attached to both levers 39, 40 and passes over lever cable pulley 27 which is attached to frame 24. Lever cable 26 functions to keep tension in the system.

The gear system in FIG. 7 has been relocated and keeps the pedals on the same path no matter what gear ratio is being utilized. This gear system is detailed in FIG. 8.

FIG. 8 discloses a gear system with gear plate 15, return gear plate 28 and drive gear plate 29 operate to alter the gear ratio in a manner similar to that described with reference to FIGS. 4 and 5. In FIG. 8, gear plate 15 supports return interface pulleys 33 and 34 and drive interface pulleys 37 and 38; return gear plate 28 supports return gear pulleys 11 and 12 and drive gear plate 29 supports drive gear pulleys 13 and 14.

Return gear plate cables 31 and 32 are each attached at one end to spring or springs 6 and at the other end to return gear plate 28; between the two ends of each return gear plate cable 31 and 32, it is wrapped around return interface pulleys 33 and 34, respectively. Drive gear plate cables 35 and 36 are each attached at one end to drive gear plate 29 and at the other end to frame 24; between the two ends of each drive gear plate cable 35 and 36, it is wrapped around drive interface pulleys 37 and 38, respectively. This arrangement allows the travel distance of the return 28 and drive 29 gear plates in comparison to the gear plate 15 to be equalized, i.e. as in FIG. 5 when gear plate 15 is moved a different gear ratio will be achieved by adding/removing drive and return cable from the helicoids. Also, the number of pulleys the drive cable 9 has to travel through in each stroke has been reduced, minimizing friction on the drive cable. While various embodiments of the present invention have been described above, it should be understood that they have been presented by way of example, and not limitation. It will be apparent to persons skilled in the relevant art that various changes in form and detail can be made therein without departing from the spirit and scope of the invention. Thus the present invention should not be limited by any of the above-described exemplary embodiments, but should be defined only in accordance with the following claims and their equivalents.

I claim:

1. A transmission mechanism comprising:
(a) a first and second helicoid and a shaft, the shaft has a first end, a second end and a drive direction, the first helicoid is attached to the shaft and the second helicoid is attached to the shaft;
(b) the a flexible drive tension transmitting component having a first drive end and a second drive end, the first drive end is attached to the first helicoid and the second drive end is attached to the second helicoid; and
whereby a first tension force transmitted through the flexible drive tension transmitting component causes a first drive portion of the flexible drive tension transmitting component adjacent the first drive end to unwind from the first helicoid and forces the shaft to rotate in the drive direction and, sequentially, a second tension force transmitted through the flexible drive tension transmitting component causes a second drive portion of the flexible drive tension transmitting component adjacent the second drive end to unwind from the second helicoid and forces the shaft to rotate in the drive direction.

2. The transmission mechanism of claim 1 further comprising:
(a) one of either a pair of pedals or a pair of handles attached to the flexible drive tension transmitting component.

3. The transmission mechanism of claim 1 further comprising:
(a) a first one way locking mechanism disposed between the first helicoid and the first end of the shaft and a second one way locking mechanism disposed between the second helicoid and the second end of the shaft.

4. The transmission mechanism of claim 3 further comprising:
(a) a return tension transmitting component having a first return end and a second return end, the first return end is attached to the first helicoid and the second return end is attached to the second helicoid; and
whereby a first return portion of the flexible return tension transmitting component adjacent the first return end winds around the first helicoid as the first helicoid rotates in the drive direction and, sequentially, a second return portion of the flexible return tension transmitting component adjacent the second return end winds around the second helicoid as the second helicoid rotates in the drive direction.

5. The transmission mechanism of claim 4 further comprising:
(a) a gearing system comprising a plurality of pulleys attached to one or more plates actuatable with respect to the first and second helicoids, whereby the flexible drive tension transmitting component and the flexible return tension transmitting component engage the plurality of pulleys and further whereby actuation of the one or more plates causes a change in the length of first and second drive portions and first and second return portions that engage each helicoid.

6. The transmission mechanism of claim 4 further comprising:
(a) gearing system means for changing in the length of first and second drive portions and first and second return portions that engage each helicoid.

7. The transmission mechanism of claim 1 wherein:

8. the first helicoid is attached adjacent the first end of the shaft and the second helicoid is attached adjacent the second end of the shaft. The transmission mechanism of claim 1 wherein:
(a) each helicoid further comprises a groove sized to receive the flexible drive tension transmitting component and the flexible return tension transmitting component.

9. A transmission mechanism comprising:
(a) a first and second helicoid and a shaft, the shaft has a drive direction, the first helicoid is attached to the shaft and the second helicoid is attached to the shaft;
(b) a flexible drive tension transmitting component having a first drive end and a second drive end, the first drive end is attached to the first helicoid and the second drive end is attached to the second helicoid;
(c) a flexible return tension transmitting component having a first return end and a second return end, the first return end is attached to the first helicoid and the second return end is attached to the second helicoid; and whereby:
(i) a first tension force transmitted through the flexible drive tension transmitting component causes a first drive portion of the flexible drive tension transmitting component adjacent the first drive end to unwind from the first helicoid and forces the shaft to rotate in the drive direction while, simultaneously, a first portion of the first flexible return tension transmitting component adjacent the first return end is caused to wind around the first helicoid and reset the second helicoid; and, sequentially,
(ii) a second tension force transmitted through the flexible drive tension transmitting component causes a second drive portion of the flexible drive tension transmitting component adjacent the second drive end to unwind from the second helicoid and force the shaft to rotate in the drive direction while, simultaneously, a second portion of the flexible return tension transmitting component adjacent the second return end is caused to wind around the second helicoid and reset the first helicoid.

10. The transmission mechanism of claim 9 further comprising:
(a) one of either a pair of pedals or a pair of handles attached to the flexible drive tension transmitting component.

11. The transmission mechanism of claim 9 further comprising:
(a) a first one way locking mechanism disposed between the first helicoid and the first end of the shaft and a second one way locking mechanism disposed between the second helicoid and the second end of the shaft.

12. The transmission mechanism of claim 9 further comprising:
(a) a gearing system comprising a plurality of pulleys attached to one or more plates actuatable with respect to the first and second helicoids, whereby the flexible drive tension transmitting component and the flexible return tension transmitting component engage the plurality of pulleys and further whereby actuation of the one or more plates causes a change in the length of first and second drive portions and first and second return portions that engage each helicoid.

13. The transmission mechanism of claim 9 wherein:
(a) each helicoid further comprises a groove sized to receive the flexible drive tension transmitting component and the flexible return tension transmitting component
